(19) United States
(12) Patent Application Publication
(10) Pub. No.: US 2020/0313224 A1
(43) Pub. Date: Oct. 1, 2020

(54) ELECTRODE PLATE AND ELECTRODE ASSEMBLY USING THE SAME

(71) Applicant: Ningde Amperex Technology Ltd., Ningde (CN)

(72) Inventors: Bin Wang, Ningde (CN); XIANG-LONG HAN, Ningde (CN); Li Xiang, Ningde (CN); Qiaoshu Hu, Ningde (CN)

(21) Appl. No.: 16/545,260

(22) Filed: Aug. 20, 2019

(30) Foreign Application Priority Data
Mar. 29, 2019 (CN) 201910251413.X

(51) Int. Cl. H01M 10/04; H01M 2/18; H01M 2/26; H01M 10/0587

(52) U.S. Cl. CPC H01M 10/0459; H01M 2/18; H01M 4/0409; H01M 10/0587; H01M 2/266

(57) ABSTRACT

An electrode plate with increased energy density includes a current collector, an active layer disposed on the current collector, and a tab electrically connected to the current collector. The current collector includes a main body and a plurality of protruding portions formed by extending the main body. The plurality of protruding portions are spaced apart from each other to define a plurality of gaps. The active layer is disposed on the main body and the plurality of protruding portions. The tab is disposed in one of the plurality of gaps. The disclosure also provides an electrode assembly using the electrode plate.

### FIELD

The subject matter herein generally relates to an electrode plate and an electrode assembly using the electrode plate.

### BACKGROUND

With the advantages of high capacity, high operating voltage, low self-discharge rate, high energy density, long service life, small size, and light weight, lithium ion batteries are widely applied in the consumer electronics. Demand for capacity, energy density, and safety of the batteries is growing.

### SUMMARY

A safe and durable electrode plate with increased energy density and an electrode assembly using the electrode plate are disclosed.

The electrode plate includes a current collector, an active layer disposed on the current collector and a tab electrically connected to the current collector. The current collector includes a main body and a plurality of protruding portions each formed by extending the main body. The plurality of protruding portions is spaced apart from each other to define a plurality of gaps. The active layer is disposed on the main body and the plurality of protruding portions. The tab is disposed in one of the plurality of gaps.

Each of the plurality of protruding portions extends in a first direction, and the tab extends beyond the protruding portion in the first direction.

An insulating region is disposed between the tab and the adjacent plurality of protruding portions.

The tab comprises a conductive region, the insulating region is formed by an extension from the conductive region in a second direction, the second direction is perpendicular to the first direction.

The current collector is a composite current collector comprising an insulating layer and a metal layer disposed on the insulating layer. The conductive region is formed by extending the insulating layer and the metal layer of the main body in the first direction, the insulating region is formed by extending the insulating layer of the conductive region.

Further, the insulating region is formed on a side of each of the plurality of protruding portions adjacent to the gap.

Further, the current collector is a composite current collector comprising an insulating layer and a metal layer disposed on the insulating layer, the insulating region is formed by extending the insulating layer of each of the plurality of protruding portions in a second direction, the second direction is perpendicular to the first direction.

Further, each of the plurality of protruding portions is formed by extending the main body by extending the main body in a first direction, a length of each of the plurality of protruding portions in the first direction is greater than or equal to 0.1 mm, and less than or equal to 5 mm.

Further, each of the plurality of protruding portions is formed by extending the main body in a first direction, a length of each of the plurality of protruding portions in the first direction is 2 mm.

An electrode assembly includes a first electrode plate, a second electrode plate, and a separator sandwiched between the first electrode plate and the second electrode plate. The first electrode plate, the separator and the second electrode plate are stacked or wound to form the electrode assembly. The first electrode plate includes a current collector, an active layer disposed on the current collector, and a first tab electrically connected to the current collector. The current collector includes a main body and plurality of protruding portions each formed by extending the main body. The plurality of protruding portions are spaced apart from each other to define a plurality of gaps. The active layer is disposed on the main body and the plurality of protruding portions. The first tab is disposed in one of the plurality of gaps. The second electrode plate comprises a second tab.

Further, the first tab is bent and soldered to an external tab to form a solder joint, and the solder point defines a transition portion; a thickness of the transition portion is less than or equal to a length of the protruding portion along the first direction.

Further, the plurality of gaps of the first electrode plate comprise a first gap provided with the first tab; and, a second gap without the first tab. Wherein the second gap corresponds to the second tab.

In the electrode plate of the present disclosure, since the electrode plate includes a plurality of protruding portions, and each tab is disposed to correspond to the gap between the spaced plurality of protruding portions, the space on both sides of each tab is effectively supported by the plurality of protruding portions when the electrode plate is subsequently packaged to form a cell or battery. Deformation and displacement of the tab and potential collapse of the top of the battery caused by the force of packaging are avoided. Being supported, the space around the tab after packaging is protected from damage, the battery is thus more secure and durable.

Moreover, since the active layer is disposed on the surface of the plurality of protruding portions, the capacity of the battery can be increased without changing the size of the battery, thereby obtaining a battery having a higher energy density.

Furthermore, the electrode plate includes either the first insulating region or the second insulating region, or can include both, which effectively prevents a short circuit between the folded tab and other regions of the electrode plate.

### BRIEF DESCRIPTION OF THE DRAWINGS

Implementations of the present disclosure will now be described, by way of embodiments, with reference to the attached figures.

FIG. 1 is a diagram of an embodiment of an electrode plate.

FIG. 2 is a cross-sectional view of an embodiment of an electrode plate taken along II-II line of FIG. 1.

FIG. 3 is a cross-sectional view of an embodiment of a tab of an electrode plate taken along line of FIG. 1.

FIG. 4 is a cross-sectional view of an embodiment of a plurality of protruding portions of an electrode plate taken along IV-IV line of FIG. 1.

FIG. 5 is a cross-sectional view of another embodiment of a tab of an electrode plate taken along line of FIG. 1.

FIG. 6 is a cross-sectional view of another embodiment of a plurality of protruding portions of an electrode plate taken along IV-IV line of FIG. 1.

FIG. 7 is a diagram of an embodiment showing a first electrode plate, a separator, and a second electrode plate stacked together.

FIG. 8 is a diagram of an embodiment of an electrode assembly.

FIG. 9 is a diagram of an embodiment of an electrode assembly.

FIG. 10 is a diagram of an embodiment of an electrode assembly.

FIG. 11 is a cross-sectional view of an embodiment of an electrode assembly taken along XI-XI line of FIG. 10.

FIG. 12 is a partial diagram of a COMPARATIVE EMBODIMENT 1 of a negative electrode plate.

FIG. 13 is a partial diagram of a COMPARATIVE EMBODIMENT 1 of a positive electrode plate.

FIG. 14 is a diagram of a COMPARATIVE EMBODIMENT 1 of a separator.

FIG. 15 is a diagram of a COMPARATIVE EMBODIMENT 2 of a negative electrode plate.

FIG. 16 is a diagram of a COMPARATIVE EMBODIMENT 2 of a positive electrode plate.

FIG. 17 is a diagram of a COMPARATIVE EMBODIMENT 2 of a separator.

FIG. 18 is a diagram of a COMPARATIVE EMBODIMENT 2 of an electrode assembly.

FIG. 19 is a partial diagram of an EMBODIMENT 1 of a negative electrode plate.

FIG. 20 is a partial diagram of an EMBODIMENT 1 of a positive electrode plate.

FIG. 21 is a diagram of an EMBODIMENT 2 of a negative electrode plate.

FIG. 22 is a diagram of an EMBODIMENT 2 of a positive electrode plate.

FIG. 23 is a diagram of an EMBODIMENT 2 of a separator.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

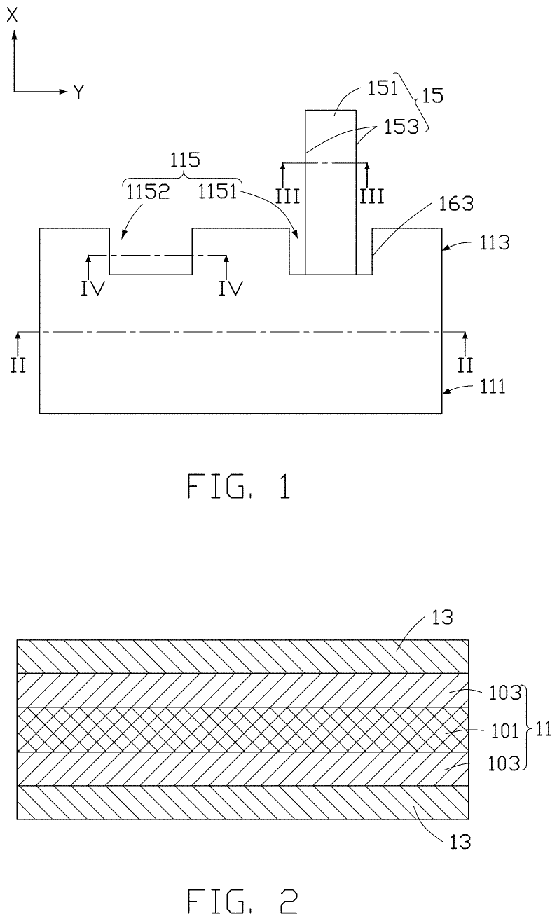

FIG. 1 illustrates an embodiment of an electrode plate 10. The electrode plate 10 includes a current collector 11, an active layer 13, and at least one tab 15. The active layer 13 is disposed on the current collector 11. Each tab 15 is electrically connected to the current collector 11.

The current collector 11 includes a main body 111 and a plurality of protruding portions 113. Each protruding portion 113 is formed by the main body 111 extending in a first direction X. The plurality of protruding portions 113 are spaced apart from each other on the main body 111 to define a plurality of gaps 115.

In at least one embodiment, a length of the protruding portion 113 in the first direction is greater than or equal to 0.1 mm, and less than or equal to 5 mm. Preferably, the length of the protruding portion 113 is 2 mm. In another embodiment, the length of the protruding portion 113 can be varied as need.

The active layer 13 is disposed on the main body 13 and the plurality of protruding portions 113.

The tab 15 is disposed in the gap 115, and extends beyond the protruding portion 113 in the first direction X.

In at least one embodiment, referring to FIG. 2, the current collector 11 may be a composite current collector, which includes an insulating layer 101 and a metal layer 103 disposed on the insulating layer 101. The composite current collector may be a single-sided composite current collector or a double-sided composite current collector.

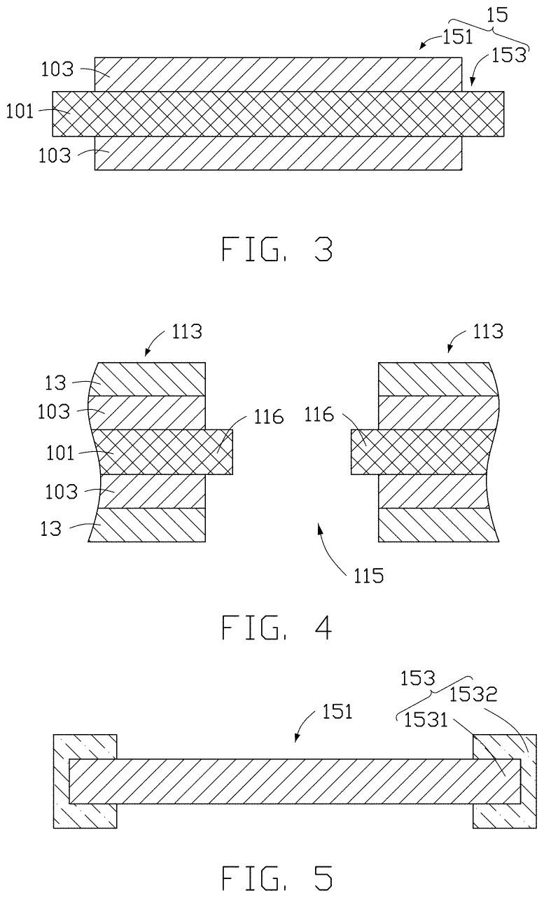

In the illustrated embodiment, referring to FIGS. 1 and 3, the tab 15 includes a conductive region 151. The conductive region 151 may be formed by extending the main body 111 of the current collector 11 in the first direction X. The tab 15 further includes a first insulating region 153. The first insulating region 153 is formed by extending from the conductive region 151 in a second direction Y. The second direction Y is perpendicular to the first direction X. The first insulating region 153 is located between the conductive region 151 and the protruding portion 113. In at least one embodiment, the first insulating region 153 is formed by extending the insulating layer 101 corresponding to the conductive region 151.

In at least one embodiment, referring to FIG. 4, the electrode plate 10 may further include a second insulating region 116. The second insulating region 116 is disposed at a side of the protruding portion 113 adjacent to the gap 115. In the illustrated embodiment, the second insulating region 116 is formed by extending the insulating layer 101 corresponding to the protruding portion 113.

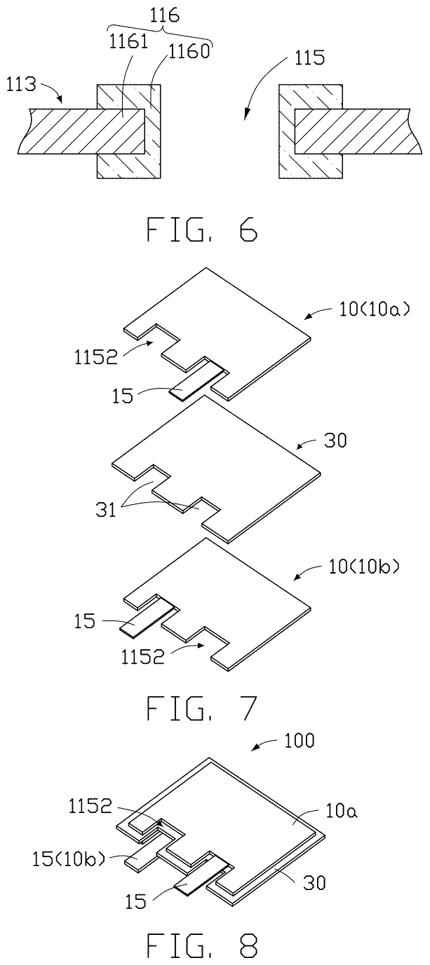

In another embodiment, referring to FIG. 5, the first insulating region 153 may include a base 1531 and an insulating film 1532 formed on an outer surface of the base 1531. The base 1531 is formed by extending the conductive layer 151. Similarly, referring to FIG. 6, the second insulating region 116 may include a substrate 1161 and an insulating film 1160 formed on an outer surface of the substrate 1161. A structure of the current collector 11 is not limited, and may be a composite current collector or a metal foil.

In at least one embodiment, referring to FIG. 1, the plurality of gaps 115 include at least one first gap 1151 and at least one second gap 1152. The tab 15 is disposed in the first gap 1151 and not in the second gap 1152. In another embodiment, the second gap 1152 may be omitted.

The electrode plate 10 may be a positive electrode plate or a negative electrode plate.

FIG. 7 illustrates an embodiment of the electrode plate 10 applied in an electrode assembly 100. The electrode assembly 100 includes at least one first electrode plate 10a, at least one second electrode plate 10b and at least one separator 30. Each separator 30 is sandwiched between one first electrode plate 10a and one second electrode plate 10b. In at least one embodiment, at least one of the first electrode plate 10a and the second electrode plate 10b can be in the form of any of the embodiments described above.

In this illustrated embodiment, a structure of the first electrode plate 10a and a structure of the second electrode plate 10b are the same as the structure of the above electrode plate 10.

Each separator 30 may define at least one opening 31 corresponding to the at least one gap 115.

FIG. 8 shows an embodiment of a stacked electrode assembly 100. The first electrode plate 10a, the separator 30, and the second electrode plate 10b are stacked in order.

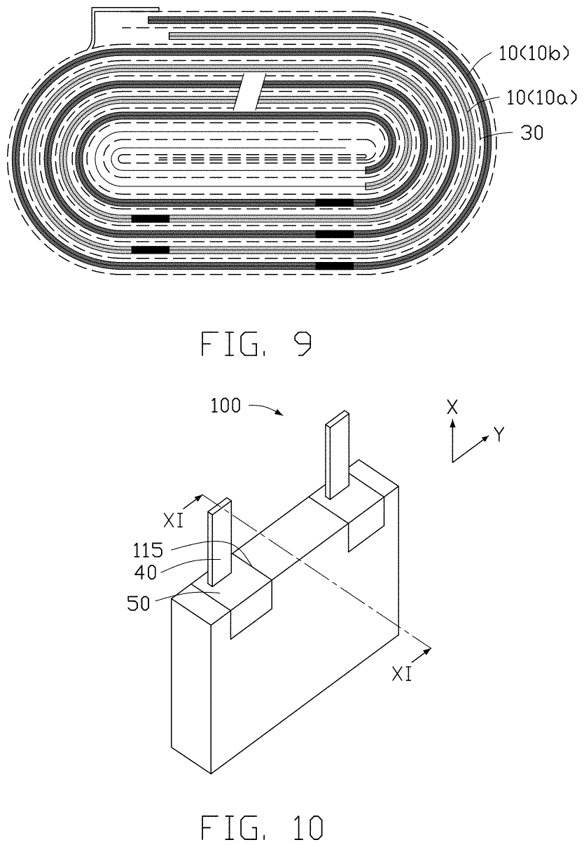

FIG. 9 shows an embodiment of a wound electrode assembly 100. The first electrode plate 10a, the separator 30, and the second electrode plate 10b are wound together to form a wound structure.

No matter whether the electrode assembly 100 is stacked or wound, when the electrode plate 10 (10a, 10b) includes the second gap 1152, the tab 15 of the first electrode plate 10a corresponds to the second gap 1152 of the second electrode plate 10b, and the second gap 1152 of the first electrode plate 10a corresponds to the tab 15 of the second electrode plate 10b.

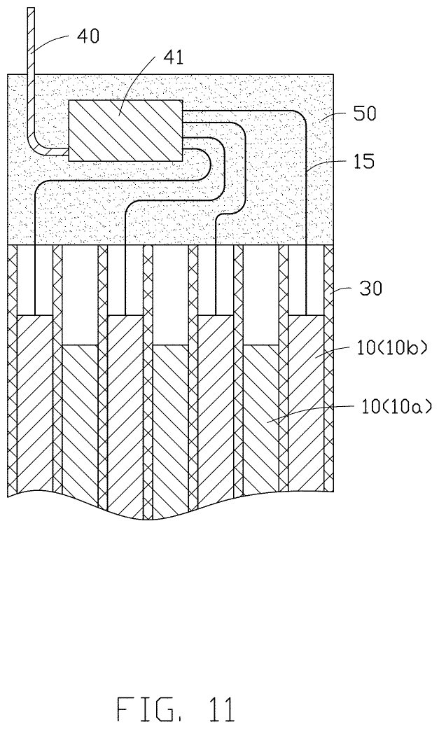

Referring to FIGS. 10 and 11, in the electrode assembly 100, the tabs 15 of the first electrode plates 10a are bent and soldered to an external tab 40 to form a solder joint, and the solder joint defines a transition portion 41. In at least one embodiment, a thickness of the transition portion 41 is less than or equal to a length of the protruding portion 113 along the first direction X. That is, the transition portion 41 is received in the gap 115 of the electrode assembly 100. Similarly, the tabs 15 of the second electrode plates 10b also can be bent and soldered to an external tab.

In at least one embodiment, the electrode assembly 100 may further include an insulating coating 50 disposed on the transition portion 41 and the tabs 15. In the illustrated embodiment, the entire transition portion 41 and the entire tabs 15 are covered by the insulating coating 50. In another embodiment, the electrode assembly 100 is received in a packaging film (not shown), the insulating coating 50 covers the entire transition portion 41 and a surface of the tabs 15 closest to the packaging film.

### Comparative Embodiment 1

An electrode plate 10 includes a current collector 11, an active layer 13, and a tab 15 formed by extending the current collector 11. The current collector 11 includes a main body 111. The active layer 13 is disposed on the main body 111.

The electrode plate 10 and a battery with the electrode plate 10 can be prepared by the following steps.

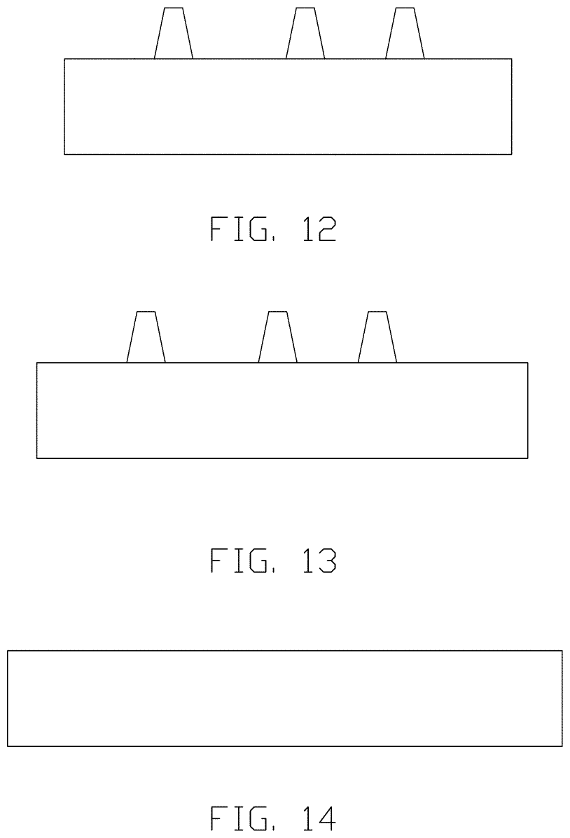

Negative electrode plate preparation: a copper foil having a thickness of 8 μm was provided as a negative current collector. A first slurry was provided by mixing graphite, sodium carboxymethycellulose (CMC), and styrene butadiene rubber (SBR) at a weight ratio of 97.5:1.5:1.0, adding water and stirring. The solid content of the second slurry was 50 percent. The first slurry was coated onto the main body of the negative current collector. The negative current collector further included a blank region without the first slurry. Then a negative electrode plate as shown in FIG. 13 was obtained by cutting out the negative current collector. The blank region corresponds to the formation of negative tabs. In the illustrated embodiment, the main body of the negative electrode plate had a length of 3050 mm in the second direction Y, and a width of 125.6 mm in the first direction X. Each negative tab had a length of 18 mm in the first direction X. A joint between each negative tab and the main body had a width of 15 mm in the second direction Y. An end of each negative tab facing away from the main body had a width of 10 mm in the second direction Y.

Positive electrode plate preparation: an aluminum foil having a thickness of 13 μm was provided as a positive current collector. A second slurry was provided by mixing a ternary cathode material with a commercial model of NCM523, Super P, and PVDF at a weight ratio of 97.5:1.0:1.5, adding NMP and stirring. The solid content of the second slurry was 75 percent. The second slurry was coated onto the positive current collector. The positive current collector further included a blank region without the second slurry. Then a positive electrode plate as shown in FIG. 12 was obtained by cutting out the positive current collector. The blank region corresponds to the formation of positive tabs. In the illustrated embodiment, the main body of the positive electrode plate had a length of 3000 mm in the second direction Y, and a width of 122.6 mm in the first direction X. Each positive tab had a length of 18 mm in the first direction X. A joint between each positive tab and the main body had a width of 15 mm in the second direction Y. An end of each positive tab facing away from the main body had a width of 10 mm in the second direction Y

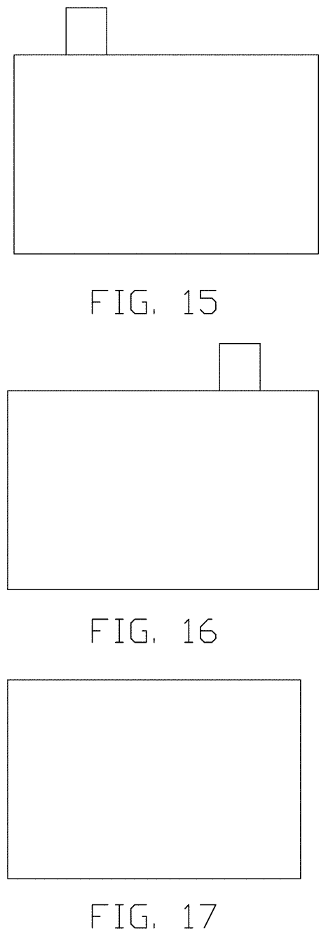

Separator preparation: a polythene (PE) film, as shown in FIG. 14, having a thickness of 9 μm was provided as a separator. In the illustrated embodiment, the separator had a length of 3250 mm, and a width of 130.6 mm.

Electrolyte preparation: an organic solvent was provided by mixing EC, EMC, and DEC at a mass ratio of 30:50:20. The electrolyte was prepared by adding LiPF₆ as lithium salt in the organic solvent to dissolve and stirring. The concentration of the lithium salt in the electrolyte was 1.15M.

Battery preparation: the positive electrode plate, the separator, and the negative electrode plate were wound together to form an electrode assembly. A tail portion of the electrode assembly was fixed by a tape, as shown in FIG. 9. The positive tabs and the negative tabs were bent and soldered with an external tab respectively, and coated by an insulating coating. The insulating coating covered the positive tabs, the negative tabs, and the solder joint, as shown in FIG. 10. The electrode assembly was received in an aluminum plastic film, and the electrolyte was injected into the aluminum plastic film, thereby obtaining the final battery.

### Comparative Embodiment 2

A structure of the electrode plate 10 in the COMPARATIVE EMBODIMENT 2 was similar to the structure of the electrode plate 10 in the COMPARATIVE EMBODIMENT 1.

In the illustrated embodiment, the electrode plate 10 and a battery with the electrode plate 10 can be prepared by the following steps.

Negative electrode plate preparation: different from the above COMPARATIVE EMBODIMENT 1, the copper foil had a thickness of 11 μm. The negative electrode plate was as shown in FIG. 16. In the illustrated embodiment, the main body of the negative electrode plate had a length of 50 mm in the second direction Y, and a width of 50 mm in the first direction X. The negative tab had a width of 6 mm in the second direction Y.

Positive electrode plate preparation: different from the above COMPARATIVE EMBODIMENT 1, the aluminum foil had a thickness of 11 μm. A second slurry was provided by mixing LiCoO₂, Super P, and PVDF at a weight ratio of 97.5:1.0:1.5, adding NMP and stirring. The solid content of the second slurry was 75 percent. The positive electrode plate was as shown in FIG. 15. In the illustrated embodiment, the main body of the positive electrode plate had a length of 49 mm in the second direction Y, and a width of 49 mm in the first direction X. The positive tab had a width of 6 mm in the second direction Y.

Separator preparation: a polythene (PE) film, as shown in FIG. 14, having a thickness of 15 μm was provided as a separator. In the illustrated embodiment, the separator had a length of 51 mm, and a width of 51 mm.

Electrolyte preparation is the same as in COMPARATIVE EMBODIMENT 1.

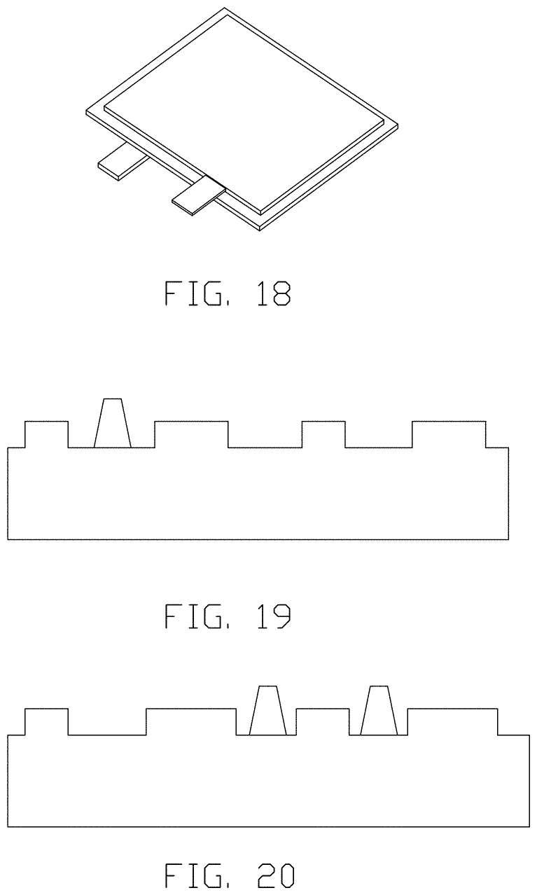

Battery preparation: different from the above COMPARATIVE EMBODIMENT 1, the positive electrode plate, the separator, and the negative electrode plate were stacked together to form an electrode assembly as shown in FIG. 18. The four corners of the electrode assembly were fixed by tape.

### Embodiment 1

In contrast to COMPARATIVE EMBODIMENT 1, the current collector 11 in EMBODIMENT 1 further includes a plurality of protruding portions 113 formed by the main body 111 extending in a first direction X. The active layer 13 is also disposed on the plurality of protruding portions 113.

In the illustrated embodiment, the electrode plate 10 and a battery with the electrode plate 10 can be prepared by the following steps.

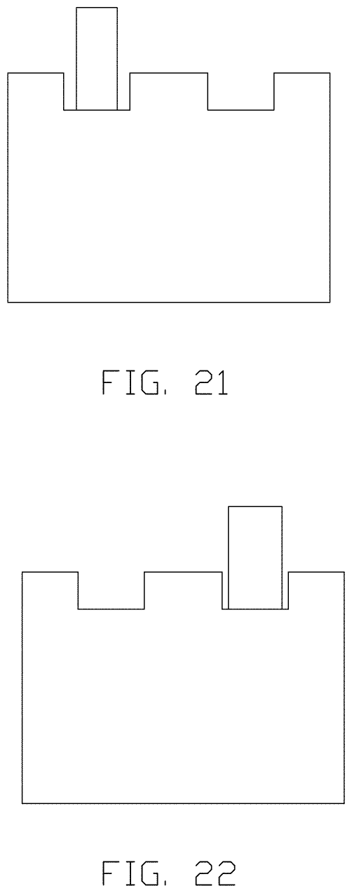

Negative electrode plate preparation: a copper foil having a thickness of 11 μm was provided as a negative current collector. A region between the plurality of protruding portions of the negative current collector was covered by a polyfoam. The first slurry of the COMPARATIVE EMBODIMENT 1 was coated onto the main body and the plurality of protruding portions to form a negative active layer. The polyfoam was peeled off after drying at 90 degrees Celsius, leaving a blank region corresponding to the region between the plurality of protruding portions. Then a negative electrode plate as shown in FIG. 20 was obtained by cutting out the negative current collector. The blank region corresponds to the formation of negative tabs. In the illustrated embodiment, the main body of the negative electrode plate had a length of 3050 mm in the second direction Y, and a width of 125.6 mm in the first direction X. Each negative tab had a length of 18 mm in the first direction X. A joint between each negative tab and the main body had a width of 15 mm in the second direction Y. An end of each negative tab facing away from the main body had a width of 10 mm in the second direction Y.

The plurality of protruding portions of the negative electrode plate had different lengths in the second direction Y. In the illustrated embodiment, the negative electrode plate included two first protruding portions and two second protruding portions, a length of the first protruding portion in the second direction Y was different from a length of the second protruding portion in the second direction Y. In the illustrated embodiment, the length of first protruding portion in the second direction Y was 16 mm, and the length of the second protruding portion in the second direction Y was 32 mm. The first protruding portion and the second protruding portion were arranged to alternate. When the negative electrode plate was wound to form a plurality of winding rings, it will be appreciated by those skilled in the art that different winding rings have different lengths, a length of the inner winding ring being less than a length of the outer winding ring. So at least one protruding portion's length in the second direction Y corresponding to each winding ring may be adjusted to adapt to the length of the winding rings. For example, the length of the first protruding portion in the second direction Y may be adjusted. The length of the innermost first protruding portion in the second direction Y was 16 mm, and the length of the first protruding portion in the second direction Y corresponding to the inner winding ring is less than the length of the first protruding portion in the second direction Y corresponding to the outer winding ring. In another embodiment, the length of each protruding portion in the second direction Y may be varied as needed, such as to obtain the desired shape of the electrode assembly.

As an example, the first one of the plurality of gaps along the second direction Y is the second gap without the negative tab disposed therein, thereby leaving a space for a positive tab. The second one and the third one along the second direction Y are the first plurality of gaps with the negative tabs disposed therein.

Positive electrode plate preparation: an aluminum foil having a thickness of 11 μm was provided as a positive current collector. A region between the plurality of protruding portions of the positive current collector was covered by a polyfoam. The second slurry of the COMPARATIVE EMBODIMENT 1 was coated onto the main body and the plurality of protruding portions to form a positive active layer. The polyfoam was peeled off after drying at 90 degrees Celsius, leaving a blank region corresponding to the region between the plurality of protruding portions. Then a positive electrode plate as shown in FIG. 19 was obtained by cutting out the positive current collector. The blank region corresponds to the formation of a positive tab. In the illustrated embodiment, the main body of the positive electrode plate had a length of 3000 mm in the second direction Y, and a width of 122.6 mm in the first direction X. Each positive tab had a length of 18 mm in the first direction X. A joint between each positive tab and the main body had a width of 15 mm in the second direction Y. An end of each positive tab facing away from the main body had a width of 10 mm in the second direction Y.

The plurality of protruding portions of the positive electrode plate had different lengths in the second direction Y. In the illustrated embodiment, the positive electrode plate included two first protruding portions and two second protruding portions, a length of the first protruding portion in the second direction Y was different from a length of the second protruding portion in the second direction Y. In the illustrated embodiment, the length of first protruding portion in the second direction Y was 16 mm, and the length of the second protruding portion in the second direction Y was 28 mm. The first protruding portion and the second protruding portion were arranged to alternate. When the positive electrode plate was wound to form a plurality of winding rings, it will be appreciated by those skilled in the art that different winding rings have different lengths, a length of the inner winding ring being less than a length of the outer winding ring. So at least one protruding portion's length in the second direction Y corresponding to each winding ring may be adjusted to adapt to the length of the winding rings. For example, the length of the first protruding portion in the second direction Y may be adjusted. The length of the innermost first protruding portion was 16 mm, and the length of the first protruding portion in the second direction Y corresponding to the inner winding ring is less than the length of the first protruding portion in the second direction Y corresponding to the outer winding ring.

As an example, the first one of the plurality of gaps along the second direction Y is the first gap with the positive tab disposed therein. The second one and the third one along the second direction Y are the second plurality of gaps without the positive tabs disposed therein, thereby leaving a space for a negative tab. When the positive electrode plate and the negative electrode plate are wound to form the electrode assembly, the first gap of the positive electrode plate corresponds to the second gap of the negative electrode plate, and the second plurality of gaps of the positive electrode plate correspond to the first plurality of gaps of the negative electrode plate.

Separator preparation is the same as for COMPARATIVE EMBODIMENT 1.

Electrolyte preparation is the same as for COMPARATIVE EMBODIMENT 1.

Battery preparation is the same as for COMPARATIVE EMBODIMENT 1.

### Embodiment 2

A structure of the electrode plate 10 in the EMBODIMENT 2 was similar to the structure of the electrode plate 10 in the EMBODIMENT 1.

In the illustrated embodiment, the electrode plate 10 and a battery with the electrode plate 10 can be prepared by the following steps.

Positive electrode plate preparation: different from the above EMBODIMENT 1, the positive electrode plate was as shown in FIG. 21. In the illustrated embodiment, the main body of the positive electrode plate had a length of 49 mm in the second direction Y, and a width of 49 mm in the first direction X. The positive tab had a width of 6 mm in the second direction Y. The positive electrode plate had three spaced protruding portions having respective lengths of 5.5 mm, 18 mm and 5.5 mm along the second direction Y. Each protruding portion had a width of 2 mm in the first direction X. A distance between two adjacent protruding portions was 10 mm. A distance between the positive tab and the adjacent protruding portion was 2 mm.

As an example, the first one of the plurality of gaps along the second direction Y is the first gap with the positive tab disposed therein. The second one along the second direction Y is the second gap without the positive tab disposed therein, thereby leaving a space for a negative tab.

Negative electrode plate preparation: different from the above EMBODIMENT 1, the negative electrode plate was as shown in FIG. 22. In the illustrated embodiment, the main body of the negative electrode plate had a length of 50 mm in the second direction Y, and a width of 50 mm in the first direction X. The negative tab had a width of 6 mm in the second direction Y. The negative electrode plate had three spaced protruding portions having respective lengths of 7 mm, 20 mm and 7 mm along the second direction Y. Each protruding portion had a width of 2 mm in the first direction X. A distance between two adjacent protruding portions was 8 mm. A distance between the positive tab and the adjacent protruding portion was 1 mm.

As an example, the first one of the plurality of gaps along the second direction Y is the second gap without the negative tab disposed therein. The second one along the second direction Y is the first gap with the negative tab disposed therein, thereby leaving a space for a positive tab. When the positive electrode plate and the negative electrode plate are stacked to form the electrode assembly, the first gap of the positive electrode plate corresponds to the second gap of the negative electrode plate, the second gap of the positive electrode plate corresponds to the first gap of the negative electrode plate.

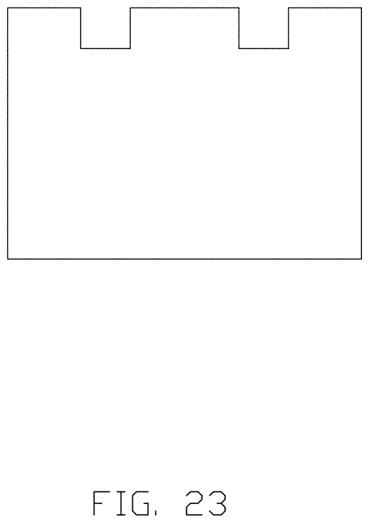

Separator preparation: a polythene (PE) film as shown in FIG. 23 having a thickness of 15 μm was provided as a separator. In the illustrated embodiment, the separator had a length of 51 mm and a width of 51 mm. The separator included three spaced protruding structures having respective lengths of 8.5 mm, 22 mm, and 8.5 mm along the second direction Y. Each protruding structure had a width of 2 mm in the first direction X. A distance between two adjacent protruding structures was 6 mm.

Electrolyte preparation is the same as for COMPARATIVE EMBODIMENT 1.

Battery preparation is the same as for COMPARATIVE EMBODIMENT 2 and as shown in FIG. 8.

### Embodiment 3

In contrast to EMBODIMENT 1, the electrode plate 10 in EMBODIMENT 3 further includes a first insulating region 153 disposed between each tab 15 and the adjacent protruding portion 113.

In the illustrated embodiment, the electrode plate 10 and a battery with the electrode plate 10 can be prepared by the following steps.

Negative electrode plate preparation: different from the above EMBODIMENT 1, the negative current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the negative tabs were formed, the metal layer corresponding to a region of each negative tab close to the adjacent plurality of protruding portions was removed, the remaining and exposed insulating layer was the first insulating region.

Positive electrode plate preparation: different from the above EMBODIMENT 1, the positive current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the positive tab was formed, the metal layer corresponding to a region of the positive tab close to the adjacent plurality of protruding portions was removed, the remaining and exposed insulating layer was the first insulating region.

Separator preparation is the same as for EMBODIMENT 1.

Electrolyte preparation is the same as for EMBODIMENT 1.

Battery preparation is the same as for EMBODIMENT 1.

### Embodiment 4

In contrast to EMBODIMENT 2, the electrode plate 10 in EMBODIMENT 4 further includes a first insulating region 153 disposed between each tab 15 and the adjacent protruding portion 113.

In the illustrated embodiment, the electrode plate 10 and a battery with the electrode plate 10 can be prepared by the following steps.

Negative electrode plate preparation: different from the above EMBODIMENT 2, the negative current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the negative tab was formed, the metal layer corresponding to a region of the negative tab close to the adjacent plurality of protruding portions was removed, the remaining and exposed insulating layer was the first insulating region.

Positive electrode plate preparation: different from the above EMBODIMENT 2, the positive current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the positive tab was formed, the metal layer corresponding to a region of the positive tab close to the adjacent plurality of protruding portions was removed, the remaining and exposed insulating layer was the first insulating region.

Separator preparation is the same as for EMBODIMENT 2.

Electrolyte preparation is the same as for EMBODIMENT 2.

Battery preparation is the same as for EMBODIMENT 2.

### Embodiment 5

In contrast to EMBODIMENT 1, the electrode plate 10 in EMBODIMENT 5 further includes a second insulating region 116 disposed between each tab 15 and the adjacent protruding portion 113.

In the illustrated embodiment, the electrode plate 10 and a battery with the electrode plate 10 can be prepared by the following steps.

Negative electrode plate preparation: different from the above EMBODIMENT 1, the negative current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the plurality of protruding portions were formed, the metal layer corresponding to a region of each protruding portion close to the plurality of gaps was removed, the remaining and exposed insulating layer was the second insulating region.

Positive electrode plate preparation: different from the above EMBODIMENT 1, the positive current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the plurality of protruding portions were formed, the metal layer corresponding to a region of each protruding portion close to the plurality of gaps was removed, the remaining and exposed insulating layer was the second insulating region.

Separator preparation is the same as for EMBODIMENT 1.

Electrolyte preparation is the same as for EMBODIMENT 1.

Battery preparation is the same as for EMBODIMENT 1.

### Embodiment 6

In contrast to EMBODIMENT 2, the electrode plate 10 in EMBODIMENT 6 further includes a second insulating region 116 disposed between each tab 15 and the adjacent protruding portion 113.

In the illustrated embodiment, the electrode plate 10 and a battery with the electrode plate 10 can be prepared by the following steps.

Negative electrode plate preparation: different from the above EMBODIMENT 2, the negative current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the plurality of protruding portions were formed, the metal layer corresponding to a region of each protruding portion close to the plurality of gaps was removed, the remaining and exposed insulating layer was the second insulating region.

Positive electrode plate preparation: different from the above EMBODIMENT 2, the positive current collector was a composite current collector including an insulating layer and a metal layer disposed on opposite surfaces of the insulating layer. The insulating layer had a thickness of 10 μm, and the metal layer on each surface of the insulating layer had a thickness of 0.5 μm. When the plurality of protruding portions were formed, the metal layer corresponding to a region of each protruding portion close to the plurality of gaps was removed, the remaining and exposed insulating layer was the second insulating region.

Separator preparation is the same as for EMBODIMENT 2.

Electrolyte preparation is the same as for EMBODIMENT 2.

Battery preparation is the same as for EMBODIMENT 2.

The volume energy density (VED) of COMPARATIVE EMBODIMENT 1-2 and EMBODIMENT 1-6 were tested. The results are shown in the following Table 1.

TABLE 1

| | | Whether the current | |
|---|---|---|---|
| | Electrode | collector have a | |
| | assembly | plurality of protruding | Capacity |
| | structure | portions or not | density |
| COMPARATIVE | wound | No | 513 |
| EMBODIMENT 1 | | | |
| COMPARATIVE | stacked | No | 501 |
| EMBODIMENT 2 | | | |
| EMBODIMENT 1 | wound | Yes | 518 |
| EMBODIMENT 2 | stacked | Yes | 511 |
| EMBODIMENT 3 | wound | Yes | 518 |
| EMBODIMENT 4 | stacked | Yes | 511 |
| EMBODIMENT 5 | wound | Yes | 518 |
| EMBODIMENT 6 | stacked | Yes | 511 |

According to the Table 1, no matter whether a battery contains a stacked or a wound electrode plate, the volume energy density of the battery including the electrode plate with the plurality of protruding portions is higher.

Since the electrode plate 10 includes the plurality of protruding portions 113, and each tab 15 is disposed to correspond to the gap 115 between the spaced plurality of protruding portions 113, the space on both sides of each tab 15 is effectively supported by the plurality of protruding portions 113 when the electrode plate 10 is subsequently packaged and finished. Deformation and displacement of the tab 15 and collapse of the top of the battery caused by the force of packaging are avoided. The space around the tab 15 after packaging is protected from damage due to being unsupported. The battery is more secure and durable. Moreover, since the active layer 13 is disposed on the surface of the plurality of protruding portions 113, the capacity of the battery can be increased without changing the size of the battery, thereby obtaining a battery having a higher energy density. Furthermore, the electrode plate 10 includes at least one of the first insulating region 153 and the second insulating region 116, which can effectively prevent a short circuit between the folded tab and other region of the electrode plate.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An electrode plate comprising:
a current collector comprising:
a main body; and
a plurality of protruding portions each formed by extending the main body;
an active layer disposed on the current collector; and
a tab electrically connected to the current collector;
wherein the plurality of protruding portions are spaced apart from each other to define a plurality of gaps, the active layer is disposed on the main body and the plurality of protruding portions, and the tab is disposed in one of the plurality of gaps.

2. The electrode plate of claim 1, wherein each of the plurality of protruding portions extends in a first direction, and the tab extends beyond the protruding portion in the first direction.

3. The electrode plate of claim 2, wherein an insulating region is disposed between the tab and the adjacent plurality of protruding portions.

4. The electrode plate of claim 3, wherein the tab comprises a conductive region, and,
the insulating region is formed by extending from the conductive region in a second direction, the second direction is perpendicular to the first direction.

5. The electrode plate of claim 4, wherein the current collector is a composite current collector comprising an insulating layer and a metal layer disposed on the insulating layer;
the conductive region is formed by extending the insulating layer and the metal layer of the main body in the first direction; and,
the insulating region is formed by extending the insulating layer of the conductive region.

6. The electrode plate of claim 3, wherein the insulating region is formed on a side of each of the plurality of protruding portions adjacent to the gap.

7. The electrode plate of claim 6, wherein the current collector is a composite current collector comprising an insulating layer and a metal layer disposed on the insulating layer, the insulating region is formed by extending the insulating layer of each of the plurality of protruding portions in a second direction, the second direction is perpendicular to the first direction.

8. The electrode plate of claim 1, wherein each of the plurality of protruding portions is formed by extending the main body in a first direction, a length of each of the plurality of protruding portions in the first direction is greater than or equal to 0.1 mm, and less than or equal to 5 mm.

9. The electrode plate of claim 1, wherein each of the plurality of protruding portions is formed by extending the main body in a first direction, a length of each of the plurality of protruding portions in the first direction is 2 mm.

10. An electrode assembly comprising: a first electrode plate, a second electrode plate, and, a separator sandwiched between the first electrode plate and the second electrode plate; the first electrode plate, the separator and the second electrode plate are stacked or wound to form the electrode assembly;
wherein the first electrode plate comprises:
a current collector comprising:
a main body; and
a plurality of protruding portions each formed by extending the main body;
an active layer disposed on the current collector; and
a first tab electrically connected to the current collector;
wherein the plurality of protruding portions are spaced apart from each other to define a plurality of gaps, the active layer is disposed on the main body and the plurality of protruding portions, and the first tab is disposed in one of the plurality of gaps; and the second electrode plate comprises a second tab.

11. The electrode assembly of claim 10, wherein each of the plurality of protruding portions extends in a first direction, and the first tab extends beyond the protruding portion in the first direction.

12. The electrode assembly of claim 11, wherein an insulating region is disposed between the first tab and the adjacent plurality of protruding portions.

13. The electrode assembly of claim 12, wherein the first tab comprises a conductive region; and,
the insulating region is formed by extending from the conductive region in a second direction, the second direction is perpendicular to the first direction.

14. The electrode assembly of claim 13, wherein the current collector is a composite current collector comprising an insulating layer and a metal layer disposed on the insulating layer;
the conductive region is formed by extending the insulating layer and the metal layer of the main body in the first direction; and,
the insulating region is formed by extending the insulating layer of the conductive region.

15. The electrode assembly of claim 12, wherein the insulating region is formed on a side of each of the plurality of protruding portions adjacent to the gap.

16. The electrode assembly of claim 15, wherein the current collector is a composite current collector comprising an insulating layer and a metal layer disposed on the insulating layer, the insulating region is formed by extending the insulating layer of each of the plurality of protruding portions in a second direction, the second direction is perpendicular to the first direction.

17. The electrode assembly of claim 10, wherein each of the plurality of protruding portions is formed by extending the main body in a first direction, a length of each of the plurality of protruding portions in the first direction is greater than or equal to 0.1 mm, and less than or equal to 5 mm.

18. The electrode assembly of claim 10, wherein the first tab is bent and soldered to an external tab to form a solder joint, and the solder point defines a transition portion; and a thickness of the transition portion is less than or equal to a length of the protruding portion along the first direction.

19. The electrode assembly of claim 18, wherein the first tab comprises a plurality of first tab units, and the plurality of first tab units are stacked to define the first tab; and each of the plurality of first tab units is correspondingly disposed in one of the plurality of gaps.

20. The electrode assembly of claim 10, wherein the plurality of gaps of the first electrode plate comprises a first gap provided with the first tab; and, a second gap without the first tab; wherein the second gap corresponds to the second tab.
